(19) United States
(12) Patent Application Publication
(10) Pub. No.: US 2002/0155618 A1
(43) Pub. Date: Oct. 24, 2002

(54) Methods of analyzing and sorting one or more analytes

(76) Inventor: David O'Hagan, Canton, MI (US)

Correspondence Address: BRINKS HOFER GILSON & LIONE, P.O. Box 10395, Chicago, IL, 60610, US

(21) Appl. No.: 10/052,220

(22) Filed: Jan. 17, 2002

Related U.S. Application Data
(60) Provisional application No. 60/262,271, filed on Jan. 17, 2001.

(51) Int. Cl. G01N 21/76

(52) U.S. Cl. 436/172; 436/164; 436/501; 422/82.08; 422/82.09; 435/7.1

(57) ABSTRACT

Microspheres having magnetic locuses and unique color addresses are provided. The microspheres are useful in a variety of assays for biomolecules, including the analysis of a sample for the presence and/or concentration of multiple analytes, as well as analyte sorting techniques. An apparatus and methods for conducting such analyses and techniques are also provided.

### REFERENCE TO PREVIOUS APPLICATIONS

This application claims the benefit of U.S. provisional application No. 60/262,271 filed on Jan. 17, 2001.

### FIELD OF THE INVENTION

The invention relates generally to apparatuses and methods for various assays of analytes, including detection of the presence and/or concentration of one or more analytes in a research or clinical sample. More particularly, the invention relates to microspheres that individually include a magnetic locus and a unique address based upon color, and analyte detection apparatuses and methods that utilize the microspheres.

### BACKGROUND OF THE INVENTION

There are numerous situations in clinical medicine and research in which it is desirable to detect the presence and/or determine the concentration of one or more analytes in a particular sample. For example, clinicians frequently monitor the level of CD4⁺ T cells (helper T cells) present in a patient's serum as an indicator of the progression from HIV infection to AIDS. Many in vitro diagnostic assays exist that allow for the analysis of one or a small number of analytes. Biomedical research of recent years, however, has identified a large number of analytes that may be of interest to both the clinician and basic researcher. This has created a need for apparatuses and methods that allow for the simultaneous analysis of numerous analytes.

For example, recent accomplishments in genomics research have led to the characterization of the genetic composition of several types of organisms, ranging from bacteria to humans. As a consequence of these advances, the DNA sequences of a great number of genes are rapidly becoming available to investigators. The availability of this genetic information allows for investigation of the involvement of a wide variety of genes in human development, disease, and other processes, such as aging. Analyses of genetic expression profiles allow an investigator to determine whether, and to what extent, a particular gene or genes is expressed during a specific condition, such as a disease state. In stark contrast to the past, the availability of genetic sequence data is no longer limiting the advancement of these investigations. Rather, the availability of methods and apparatuses for efficient utilization of the large amount of genetic information that is now available currently stands as a limiting factor to these investigations.

Genetic microarrays represent a recent development in the field of functional genomics that allow investigators to analyze genetic expression profiles. Microarrays typically consists of a physical array of genetic probes deposited onto a solid support, such as a glass slide. These devices allow investigators to evaluate the expression profile of several genes at once by providing a unique, position dependent address to each genetic probe in the array. By determining if a particular probe has bound to its hybrid, the analyte, following exposure to a sample, an investigator learns whether the gene was expressed. Due to the number of genetic probes on a single solid support, microarrays allow the investigator to simultaneously conduct a plurality of these evaluations.

While microarray technology has advanced functional genomics, several drawbacks and limitations exist. For example, the process of manufacturing microarrays is quite complex due to the need for the ordered arrangement of probes on the solid support. Typically, the genetic probes are robotically spotted onto the solid substrate, which necessitates the use of intricate manufacturing equipment. Furthermore, the number of probes on a given microarray is physically limited by the size of the solid support. This can make it difficult for an investigator to fabricate his or her own microarray.

The analysis of genetic expression profiles represents only a single application of analyte detection techniques. Several other applications are used in both the clinical and research laboratory, including the detection of antibodies and/or antigens, cells and/or cell markers, and biologically relevant entities such as insulin. As with genomics, recent research has greatly expanded the number of identified and characterized analytes for each of these applications.

Several examples, of apparatuses for detecting analytes are known in the art. For example, flow cytometers are devices that utilize lasers to evaluate a sample on a limited number of parameters, such as particle size and ligand binding. General information on flow cytometry can be found in Shapiro, “Practical Flow Cytometry,” Third Edition (Alan R. Liss Inc. 1995) and Melamed et al., “Flow Cytometry and Sorting,” Second Ed. (Wiley-Liss 1990). Flow cytometry is limited, however, by the number of different light sources present in the equipment. Typical flow cytometers include 2 or 4 lasers, which greatly limits the number of analytes that can be analyzed by the machine.

To overcome these limitations, several attempts have been made to introduce a unique parameter that is independent of the flow cytometer or other detection equipment and that identifies a particular analyte as distinct from others being evaluated. For example, U.S. Pat. No. 6,100,026 to Nova et al., for MATRICES WITH MEMORIES AND USES THEREOF describes solid supports that include a bar code on their surface as a means to identify a particular analyte. Also, U.S. Pat. No. 5,981,180 to Chandler et al. for MULTIPLEXED ANALYSIS OF CLINICAL SPECIMENS APPARATUS AND METHODS describes solid supports that utilize fluorescence to distinguish multiple analytes from each other.

These technologies are also limited, however. For example, placing a bar code on the surface of a microsphere or other similar particle undoubtedly requires very delicate manufacturing procedures. Furthermore, the use of fluorescence to identify particular microspheres and/or analytes because the wavelength of light emitted by fluorophores can overlap due to cross-talk. To avoid this, a limited number of fluorophores are usually employed, which of course limits the number of unique microspheres and/or analytes that can be analyzed.

### SUMMARY OF THE INVENTION

The present invention provides apparatuses and methods useful for performing analyses of one or more analytes. The apparatuses and methods can be used to evaluate a sample for the presence and/or concentration of a variety of analytes, including polynucleotides, antibodies and/or antigens, drug compounds, and even whole cells. Indeed, the present invention can be used to analyze any analyte that can be bound to a particular ligand.

A preferred method of analyzing a sample for the presence of one or more analytes according to the present invention comprises contacting the sample with a plurality of microspheres according to the present invention, detecting a level of fluorescence associated with each microsphere, determining the color-based address of each microsphere, and correlating, or combining in a meaningful manner, the level of fluorescence and color-based address for each of the plurality of microspheres.

The present invention also provides methods of sorting one or more analytes from a sample containing a plurality of analytes. A preferred method of sorting comprises contacting the sample with a plurality of microspheres according to the present invention, determining the color-based address of each microsphere, and directing each of the plurality of microspheres into an appropriate chamber selected from a plurality of chambers. The directing of microspheres is preferably based upon the determining of the color-based address. That is, microspheres are preferably sorted based upon their color-based address.

Also, the present invention provides a platform technology that can be utilized in a variety of manners. For example, the present invention can be utilized in biosynthetic methods that require step-wise processing, such as polynucleotide synthesis.

Furthermore, the present invention provides for libraries and subsets of microspheres having unique, color-based addresses, which will be useful for analyzing samples for groups of related analytes.

### BRIEF DESCRIPTION OF THE DRAWINGS

FIG. 1 presents a schematic of a microsphere in accordance with the present invention;

FIG. 2 is a cross-sectional view of an alternative embodiment of a microsphere in accordance with the present invention;

FIG. 3 presents a schematic of microspheres in accordance with the present invention. The individual microspheres shown in panels a-d have different types of ligands attached to the surfaces;

FIG. 4 presents a block diagram of an analysis apparatus in accordance with the present invention;

FIG. 5 is a schematic that illustrates the two optical determinations performed by the analysis apparatus in accordance with the present invention: the detection of fluorescence emission to detect the presence of an analyte and the determination of an absorbance spectra to determine the color address of the microsphere.

FIG. 6 presents a schematic diagram of the fluidics systems of the apparatus according to the present invention;

FIG. 7 presents a schematic of the modular architecture of the apparatus according to the present invention;

FIG. 8 presents a schematic of a flow stream undergoing magnetic focusing in accordance with the present invention;

FIG. 9 presents a schematic of a microsphere being preferentially routed down a particular path by the selective application of particular magnetic fields.

FIG. 10 presents schematic diagrams of the mechanical manipulation of microspheres according to the present invention;

FIG. 11 presents a schematic of the inter-relationship of the apparatus according to the present invention and a look-up table containing data for each specific address of microspheres in accordance with the present invention;

FIG. 12 presents a schematic diagram of a method of synthesizing an polynucleotide using the apparatus of the present invention.

### DETAILED DESCRIPTION OF THE INVENTION

The following description of preferred embodiments and methods provides examples of the present invention. The embodiments discussed herein are merely exemplary in nature, and are not intended to limit the scope of the invention in any manner. Rather, the description of these preferred embodiments and methods serves to enable a person of ordinary skill in the relevant art to make, use and perform the present invention.

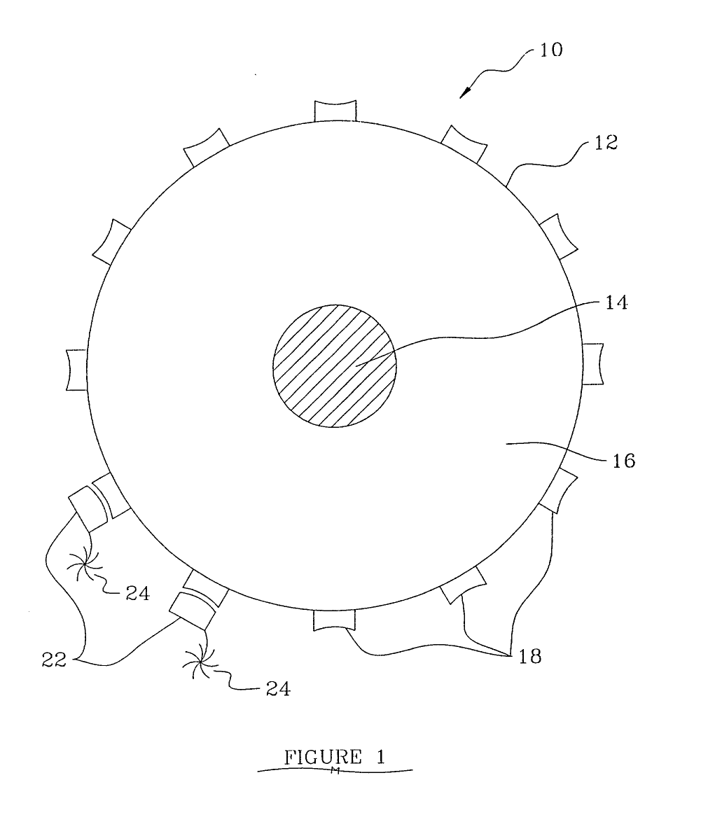

FIG. 1 illustrates a microsphere 10 in accordance with the present invention. The microsphere 10 comprises a solid support having an exterior surface 12. The microsphere may include a magnetic locus 14. Individual microspheres 10 have a specific color address 16 that preferably comprises a specific blend of color dyes throughout the microsphere 10. A ligand 18 is present on the surface 12 of the microsphere 10, allowing the microsphere 10 to bind to an analyte of interest.

Microspheres have previously been used in a variety of scientific applications including chemical synthesis and separation and/or purification methods. The preparation and use of standard microspheres is known to those skilled in the art. Indeed, microspheres of various sizes and materials are readily available from several commercial sources. For example, microspheres composed of natural materials, such as agarose and cellulose, as well as synthetic materials, such as glass, polystyrene, nylon, and other polymeric materials, are readily available. Essentially any solid support that allows light to transmit through the microsphere and is able to retain the color dyes of the address can be used. Typical microspheres vary in size from approximately 0.2 μm to 100 μm in diameter.

Microspheres according to the present invention can be prepared by using standard microspheres known in the art. For example, a magnetic locus, if desired, can be secured to a region of the exterior surface of a standard microsphere. Also, the microsphere can be doped with a blend of color dyes to create the color address. Preferably, however, microspheres according to the present invention are prepared by forming the microsphere and simultaneously doping the microsphere with one or more dyes to create the color address. If a magnetic locus is desired, the forming can be done around a magnetic locus. The microsphere can be built by polymerizing a desired monomer or by building successive layers around each other, or by any other suitable method.

Due to its ease of handling, ready availability, and ability to efficiently bind a variety of ligands, polystyrene is a preferred material for microspheres according to the present invention. Alternatively, of course, the microspheres can be composed from any suitable material. Also preferable, microspheres according to the present invention preferably comprise substantially spherical particles that individually have a diameter of between approximately 5 μm and 30 μm. More preferably, the microspheres have a diameter of approximately 15 μm. The 15 μm size represents a balance between size and signal to noise ratio. These preferred diameters provide microspheres of a size that permits attachment of ligands to the surface and analysis using the apparatus and methods of the present invention, as described below. It should be noted that while a spherical shape is preferred, any suitable shape can be utilized for the microspheres.

As indicated above and shown in the figure, microspheres 10 in accordance with the present invention can include a magnetic locus 14 and do include color address 16. The magnetic locus 14 facilitates the use of the microspheres 10 with the analysis apparatus of the present invention, which will be developed more fully below (e.g. the magnetic locus 14 facilitates physical manipulation of the microsphere for operations such as sorting and delaying). The magnetic locus 14 can comprise any material that confers the desired behavior within a magnetic field which will be developed more fully below, onto the microsphere 10 such that it can be manipulated in a magnetic field. Preferably, the locus 14 represents a spherical particle of a super-paramagnetic material, such as iron. The magnetic locus 14 need only be somehow associated with the solid support. For example, as shown in FIG. 1, the locus 14 can be embedded inside the microsphere or can comprise a patch of material deposited in a region of the exterior surface of the microsphere. If the locus is on the exterior surface, it should be positioned such that it does not interfere with optical determination of the color address. Thus, the locus cannot comprise an exterior shell that completely surrounds the microsphere. Preferably, as shown in the figure, the locus 14 is centrally disposed within the microsphere 10.

Alternatively, the locus can comprise any material that confers the desired behavior within a magnetic field onto the microsphere. Also alternatively, the magnetic locus can be disposed in any position within the microsphere. For example, the locus may be offset from the center of the microsphere, allowing a magnetic field applied to the microsphere to affect one side of the microsphere in one manner, and another side in a second manner.

The color address of an individual microsphere represents the light properties of the microsphere and provides a unique identifier that distinguishes a particular microsphere from other microspheres in a particular library. The color address represents either the direct transmittance, reflectance, or the absorption of light of a particular wavelength(s). Preferably, as shown in FIG. 1, the color address 16 comprises one or more color dyes doped into the substrate provided by the microsphere. Suitable dyes for use in the present invention include those detailed in U.S. Pat. No. 5,585,469 to Kojima et al. for DYEING AGENT HAVING AT LEAST TWO DYES FOR STAINING A BIOLOGICAL SAMPLE AND STAINING METHOD EMPLOYING THE DYEING AGENT. Particularly preferable, the color address comprises a blend of multiple dyes. Also particularly preferred, the color address comprises a blend of four dyes (preferably red, blue, green and yellow) doped throughout the microsphere. That is, as shown in the figure, it is preferred that the microsphere 10 include a blend of dye(s) throughout its entirety, except for the magnetic locus 14. As used herein, blend refers to a mixture of dyes that provides a uniform distribution of a color that results from the mixture. Alternatively, any suitable number of dyes can be utilized.

Also preferable, the dyes chosen have peak transmittance, reflectance, or absorption wavelengths that, as a group, eliminate or minimize overlap of these values between individual dyes.

The color address of an individual microsphere is preferably detected by passing white light through the microsphere and measuring the transmittance, reflectance, or absorption of light, as appropriate, of specific wavelengths of light by the dye(s) doped into the microsphere. Preferably, the color address is determined by determining an absorption spectra of light that has encountered the microsphere. The wavelengths either transmitted, reflected or absorbed will depend on the presence and concentration of the dye(s) in the microsphere. A higher concentration of a particular dye present in a microsphere will result in more light of the appropriate wavelength being transmitted, reflected, or absorbed. In a preferred embodiment, absorption values comprise the color address.

Thus, the microspheres of the present invention are distinguishable from each other based on two parameters: the presence or absence of particular dyes and the concentration of the dyes. The color address represents a value assigned to an individual microsphere based on these properties. Preferably, ten different concentration levels of four different dyes are used in the microspheres. The concentrations used will vary, but preferably the concentrations proceed in a regular interval. For example, it is preferred that the tenth concentration of a dye be 100-fold higher than the first, with each interval between concentration levels representing a 10-fold increase in concentration. Suitable concentration increases are those that allow for accurate discrimination between concentration levels in accordance with the present invention. This arrangement allows for the achievement of 10,000 unique color addresses (see Example 1). That is, using this arrangement, 10,000 microspheres, each having a unique identity, can be prepared. As a consequence, a single library of microspheres can be used to analyze up to 10,000 different analytes.

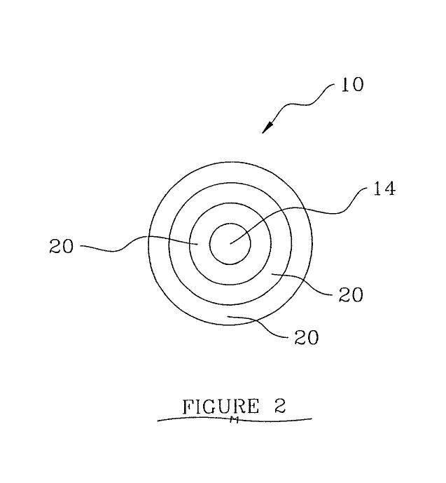

Alternatively, as shown in FIG. 2, a layered arrangement of dyes or other coloration means can be utilized to provide the color address. In this embodiment, the microsphere is colored in layers 20, preferably extending outward from the locus 14, if present. Each layer 20 has a specific color obtained by blending one or more dyes as outlined above. To resolve the address 16 of microspheres 10 of this embodiment, a confocal optical system can be utilized. This optical approach allows detection of light from only a specific confocal section of the microsphere 10 (the image plane with a shallow depth of field). By analyzing a confocal section of a microsphere 10 according to this embodiment, a color code or address 16 is obtained that is similar to a bar code (e.g., alternating bands of color assign a value to the microsphere 10).

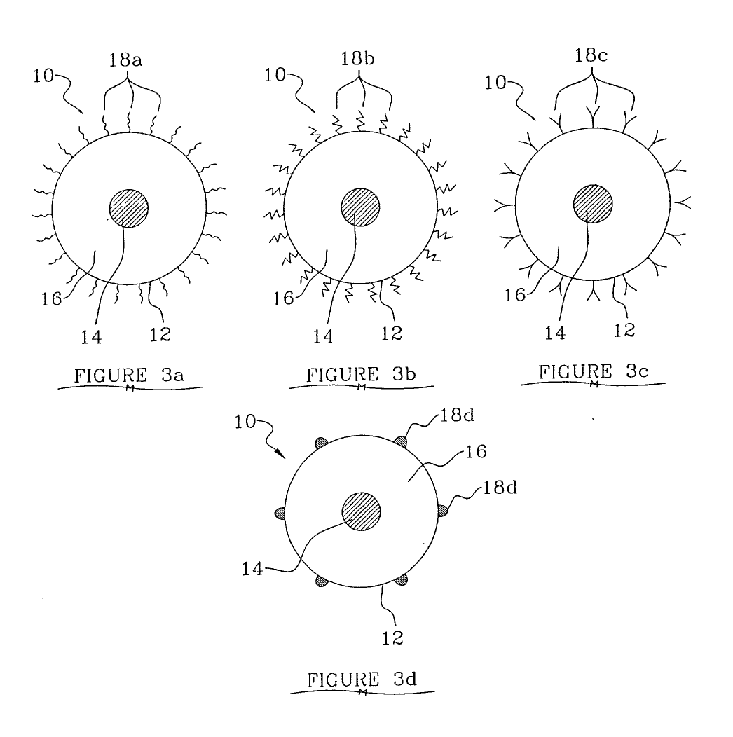

FIG. 3 depicts several microspheres 10 for use in the apparatus of the present invention and illustrates the various types of ligands 18 that can be present on the surface 12 of the microsphere 10. FIG. 3a shows a microsphere 10 having a single-stranded polynucleotide probe as the ligand 18a. FIG. 3b shows that the ligand 18 can comprise a polynucleotide probe 18b. FIG. 3c shows that the ligand 18 can comprise a monoclonal or polyclonal antibody 18c. FIG. 3d illustrates the use of a drug compound 18d as the ligand. It is important to note, however, that these illustrations are exemplary in nature and are not intended to limit the invention in any manner. Thus, it will be appreciated that the ligand 18 can comprise any molecule or substance that can be attached to the microsphere 10 and is capable of binding an analyte 20.

As best illustrated in FIG. 1, the ligands 18 present on the surface 12 of the microsphere 10 bind, in a specific chemical manner, the corresponding analyte 22, if present in the sample being evaluated. For example, if the ligand is a single-stranded DNA probe, the ligand will bind an analyte comprising a single-stranded piece of DNA that contains sufficient base homology with the ligand to biochemically bind the ligand. Thus, the analyte is a molecule or other substance present in a sample being evaluated that is able to bind, in a chemically specific manner, to the ligand present on the surface of a microsphere. Suitable analytes include polynucleotides such as mRNA and cDNA, proteins, antigens, sugars, whole cells, chemical species, cell-bound receptors, cytokines, metabolites, and drugs. To allow detection of this binding by the analysis device of the present invention, the analyte(s) 22 can be labeled with a fluorescent tag 24. Fluorescent tags are commonly used in the art as a tool for identifying a particular entity, and one skilled in the art will be familiar with their selection and use. A variety of fluorophores can be used as the tag. Preferred fluorescent tags include Fluorosceine Isothiocyanate (FITC), Cy3, and Cy5. Alternatively, any suitable fluorescent tag can be utilized. Fluorescent tags can be added to the analytes present in a sample according to methods known in the art.

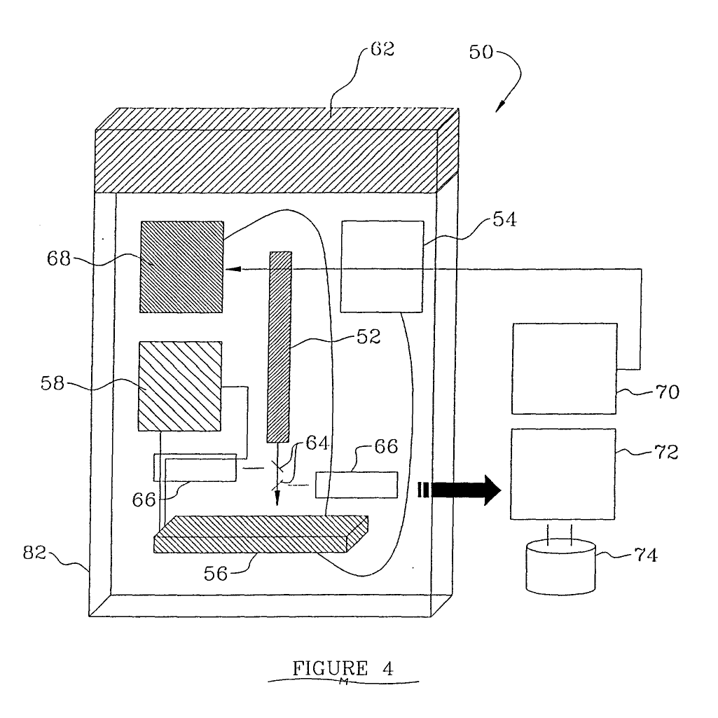

Now, the analysis apparatus of the present invention will be described. FIG. 4 presents a block diagram of a preferred embodiment of the analysis apparatus. The microsphere analyzer 50 according to the present invention comprises a series of components designed for the analysis of microspheres having specific color addresses and ligands attached on their surface. It should be noted that various collections of microspheres can be utilized when performing analyses with the apparatus of the present invention. For example, the minimum requirement is the use of a single microsphere having a color address. However, more complex collections can be utilized, such as the library and subsets of microspheres described in Examples 1 and 2, respectively. Thus, depending on the needs of the user, a set of microspheres having a common color address and a common surface ligand can be utilized. Also, a user can utilize multiple sets of microspheres, each set comprising at least a single microsphere and having a common color address and a common surface ligand. Lastly, a user can utilize a plurality of microspheres representing a plurality of unique color addresses and surface ligands. The only restriction on the collection of microspheres that can be used is that, in order to provide meaningful data, each color address must somehow correlate to a surface ligand, quantity of surface ligand, physical arrangement of surface ligand, absence of surface ligand, or some other characteristic of the ligand.

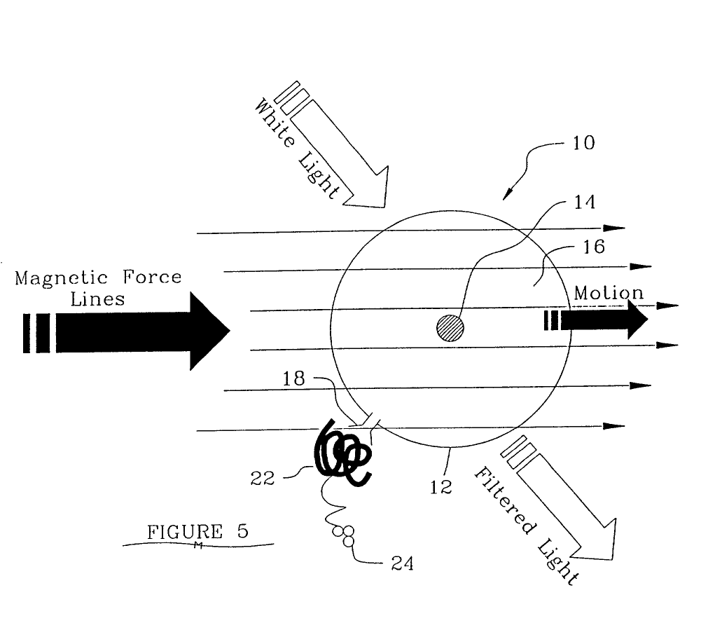

The microsphere analyzer 50 according to the present invention detects the presence of an analyte having a fluorescent tag bound to a ligand on the surface of a microsphere and resolves the color address of the particular microsphere to determine which analyte is present in the sample. These two distinct determinations are illustrated in FIG. 5. To accomplish this, the microsphere analyzer 50 uses optics to resolve the color address of individual microspheres and to determine whether an analyte has bound to an individual microsphere. Thus, the analyzer 50 includes various components for achieving both detection of fluorescence and measurement of transmittance, reflectance, or absorption spectra. Also, microspheres are preferably handled by the analyzer 50 while suspended in a fluid carrier, such as a buffered solution.

Considering these characteristics, the analyzer, as best illustrated in FIG. 4, preferably comprises one or more lasers 52, a light source 54, one or more flow chambers 56, various fluidics tanks 58 and passageways 60, and one or more power sources 62. Also, the microsphere analyzer 50 may further include various dichroic mirrors 64, one or more photomultiplier tubes 66, various signal detectors 68, a signal processor 70, an attached computer 72, a look-up table 74, and a graphical user interface 76. Also, the microsphere analyzer 50 preferably includes one or more spectrophotometers 78 for resolving the specific address that corresponds to the doped color address in the microspheres. Near the spectrophotometers 78, the microsphere analyzer includes one or more quartz imaging windows 80 that allows the spectrophotometers 78 to determine emission and/or absorption spectra on a microsphere during a spectral analysis. A support frame 82 provides a framework to which one or more of the above-listed components can be secured.

The analyzer detects the color address of individual microspheres as they flow through the device. As detailed above, the color address is based upon color, and preferably is based upon a blend of dyes doped into the microsphere. The address is determined by assessing the interaction between the dyes of the microsphere and rays of light. That is, a measurement of transmittance, reflectance, or absorption is taken. Preferably, the address is determined by taking an absorption spectra of white light that has encountered the microsphere. Accordingly, the analyzer preferably includes a source of white light 83 and one or more spectrophotometers. The light source preferably comprises a Xenon light source. Xenon is preferred because it is a readily available, broad band white light source. Alternatively, other suitable light sources, such as LEDs and lasers, can be utilized.

For example, the light source may comprise a series of light diodes representing peak values of dye absorbance for dyes used in the color address of the microspheres of interest.

Any suitable spectrophotometer can be used in the analyzer. These devices are known in the art and will not be described in great detail herein. The selection of spectrophotometer(s) should be such that an absorption spectra appropriate for the range of color addresses being used can be generated. Various configurations can be used. For example, a diffraction gradient in combination with a linear CCD array can be used. Also, an array of photodiodes can be used, or dichroic mirrors in combination with separate photodiode detectors adapted to detect different colors of light can be used. Preferably, a linear array of photodiodes is used for each spectrophotometer.

The analyzer may detect the presence of a fluorescent tag associated with an individual microsphere to determine, for example, if the particular analyte for the respective ligand is present in the sample. The detection of the fluorescent signal is based upon conventional methods and components used in flow cytometers known in the art. As such, the operation of a typical flow cytometer will be described only briefly. Flow cytometers use a sheath fluid to focus a cell or particle suspension into the center of a flow stream one cell or particle at a time. The flow stream, in its single cell or particle configuration, is directed at a flow chamber. The flow chamber is exposed to a laser that is passed through various focusing optics to direct it upon the cell and/or particle present in the flow chamber. The forward scatter and side scatter of the laser beam, after interacting with the cell or particle, can be measured. Furthermore, the presence of fluorescence can also be detected. Thus, a typical flow cytometer can measure at least three parameters for each cell and/or particle passing through the flow chamber. Indeed, many readily available flow cytometers are capable of detecting fluorescence at multiple wavelengths, and each wavelength adds an additional degree to which analyses can be performed. Detection devices collect signals on forward light scatter, side scatter, and fluorescence and pass the signals along to a signal processor. The signal processor eventually passes the signal to a computer which displays the signals in a meaningful manner to a user. The signals are ultimately used to determine, for example, if a particular population of cells, such as CD4⁺ T cells, are present in a sample based on size and presence of fluorescence associated with a cell marker, such as a monoclonal antibody directed against the CD4 marker and containing a fluorescent tag.

As shown in FIG. 4, the analyzer 50 includes one or more lasers 52 directed at a flow chamber 56 for carrying out the fluorescence detection. As indicated above, this detection is conducted in accordance with standard principles of flow cytometry. The analyzer 50 includes signal detectors 68 for forward light scatter, side scatter, as well as appropriate fluorescence detectors, and further includes a signal processor 70 for gathering signals from the various detectors 68, and a computer 72. While conventional flow cytometers need additional lasers to increase the complexity of the analyses they can perform, the analyzer of the present invention need only a single laser because all analytes being evaluated can be tagged with the same fluorescent tag due to the unique color address of individual microspheres. Of course, more than one laser can be included in the analyzer if desired, allowing for the use of additional fluorescent tags, experimental controls, or for other purposes.

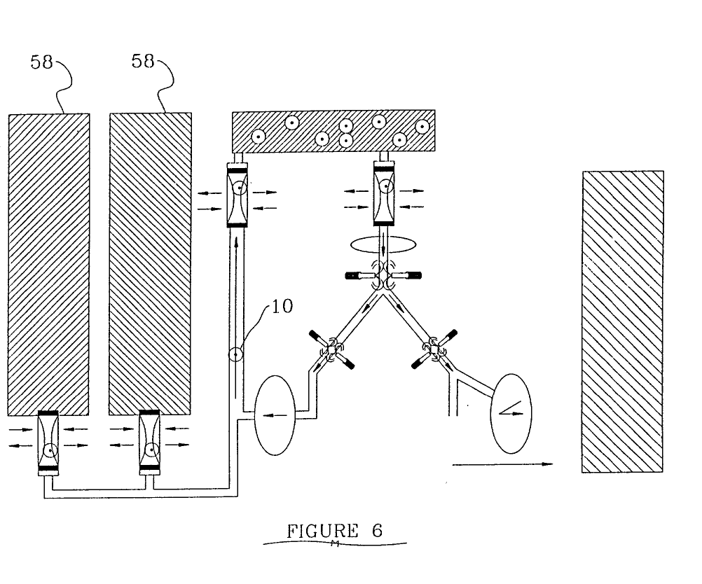

As illustrated in FIG. 6, the fluidics system of the microsphere analyzer 50 includes various tanks 58 and passageways 60, and is responsible for maintaining an environment within the analyzer 50 that is suitable for maintaining the binding relationship between the ligand and any bound analytes. The fluidics tanks 58 consist of various tanks and/or other containers suitable for holding appropriate solutions, such as physiological saline, and any buffers appropriate for the particular ligand and analytes present in any particular analysis being performed by the microsphere analyzer 50. Also, the fluidics passageways 60 may comprise various pipes, channels, tubes, connections, and any other devices and/or apparatus appropriate for moving fluid and microspheres from one area to another. Furthermore, the fluidics system of the microsphere analyzer 50 may include one or more pumps 60 that maintain fluid levels in the tanks 58 and/or passageways 60. Also, one or more sensors 84 may be placed about the fluidics tanks 58 and passageways 60, the flow chamber 56, and other areas of the microsphere analyzer 50 to detect changes in the fluid environment, including fluid levels and chemical properties, such as pH and saline content.

Because the microsphere analyzer performs two separate optical determinations, specifically a fluorescence detection and a spectral detection, precise timing between these two analyses must be accomplished in order to ensure an accurate correlation of fluorescence data with the appropriate color address. Spectral analysis typically takes a length of time and requires a stationary object. On the other hand, fluorescence detection occurs relatively rapidly, and can be conducted on a particle or cell while it is moving in the flow stream. Due to the fact that the microsphere analyzer of the present invention utilizes both spectral and fluorescence detections, a mechanism to ensure the correlation of data resulting from these two separate detections is required.

Because typical spectral analysis takes longer than the fluorescence detection, several microspheres will pass out of fluorescence detection and enter spectral detection for each microsphere that undergoes spectral detection. To allow the microsphere analyzer to accomplish the precise timing that ensures accurate correlation between data acquired from the fluorescence and spectral detections, a preferred embodiment of the microsphere analyzer of the present invention includes a modular architecture that allows the use of multiple spectrophotometers. The number of spectrophotometers is preferably sufficient to allow one cycle through all spectrophotometers to occur during approximately the time it takes to determine fluorescence for the same number of microspheres. That is, it is preferred that n microspheres can be analyzed for fluorescence in about the time it takes to cycle n microspheres through n spectrophotometers. However, as will be developed more fully below, various approaches can be used to delay or accelerate cycling through the spectrophotometers, if desired or appropriate.

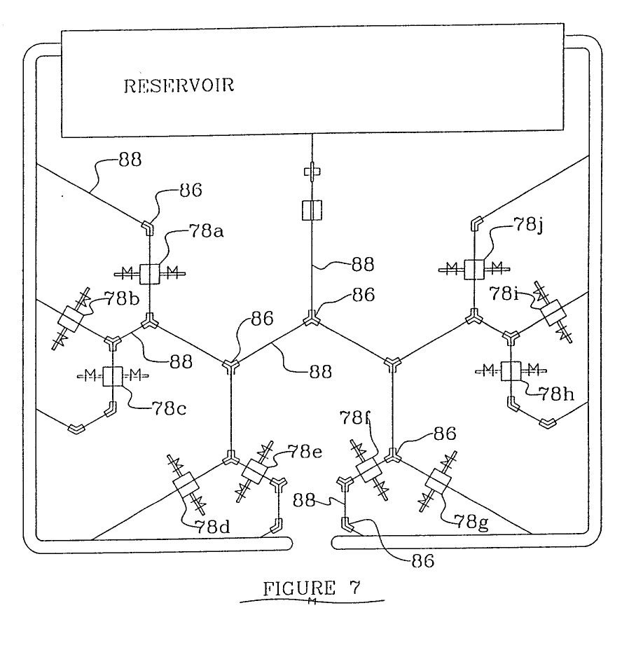

In the preferred embodiment, illustrated in FIG. 7, the microsphere analyzer 50 includes ten separate and distinct spectrophotometers 78. As fluorescence detection occurs, microspheres are routed to the different spectrophotometers 78 in a sequential manner. That is, after fluorescence detection, one microsphere is routed to a first spectrophotometer 78a. Next, after fluorescence detection, a second microsphere is routed to a second spectrophotometer 78b. Next, a third microsphere, after fluorescence detection, is routed to a third spectrophotometer 78c. This process is repeated until microspheres 10 are routed to each of the ten spectrophotometers 78. The selective routing of microspheres is preferably accomplished by manipulating the microspheres by passing them, individually, through an appropriate magnetic field or fields. By selectively turning the field(s) on or off, the microsphere is routed down the appropriate passageway that leads to the appropriate spectrophotometer. These manipulations of microspheres are developed more fully below. After determination of absorption spectra, the microsphere is released, making that spectrophotometer 78 available for another microsphere. After a microsphere is routed to the tenth spectrophotometer 78j, the next microsphere, following fluorescence detection, is routed to the first spectrophotometer 78a, which has released its first microsphere, and the process begins anew. This arrangement allows a microsphere to reside at the spectrophotometer 78 for spectral detection for the required time without creating a back-up of microspheres as they leave fluorescence detection. Preferably, the spectral detection occurs for 1 to 1000 times the length of the fluorescence detection. Particularly preferable, the data acquisition for the spectral detection occurs for approximately 50 microseconds. The length of the spectral detection period will of course depend on various factors, including the capabilities of the individual spectrophotometers, the complexity of the color address(es), and the length of the fluorescence detection period. Preferably, the spectral detection period for an individual microsphere is approximately ten times the length of the fluorescence detection period.

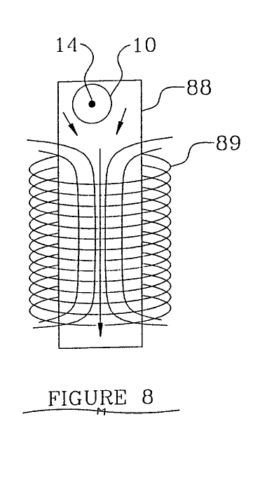

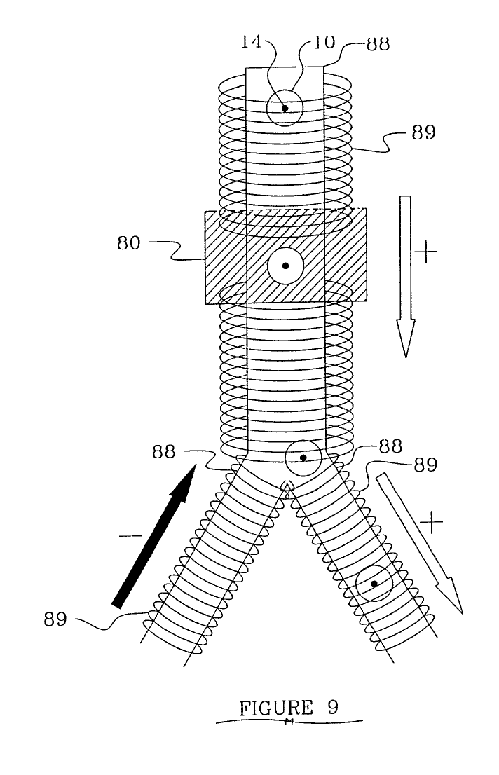

The arrangement of multiple spectrophotometers within the microsphere analyzer is accomplished by a modular architecture which allows customized path design. As best illustrated in FIG. 7, the modular architecture arises out of the use of connectors 86 and tubes 88 of various lengths. The tubes 88 are preferably glass, but may be plastic or any other material. Also, the tubes 88 can be straight, curvilinear, or forked, or in any other suitable configuration. The use of tubes 88 allows for the use of small wire (e.g. 10 micrometer diameter copper wire) to form one or more toroids or coils 89 around the tubes 88 for magnetic focusing and other manipulations of the microspheres (shown in FIGS. 8 and 9). The coils 89 are preferably formed by multiple rotations of the chosen wire around the tube 88. The coils 89 are connected to a source of electric current in a manner that allows rapid initiation and termination of current flow. In this manner, the force exerted on the magnetic microsphere will be dependent on several factors, including the number of turns in the coil per unit of length of the tube, the current, and polarity. The connectors 86 are preferably plastic, but may be any other suitable material. The modularity of the device is not dependant on using tubes 88 and connectors 86. Alternatively micro-channels will be produced using micro-electromechanical systems (MEMS) technology, similar to the production of semi-conducting chips. Also, alternatively suitable manufacturing techniques that allow for modular designs can be utilized.

The use of multiple spectrophotometers is only one approach to achieving the desired correlation between fluorescence detection and spectral detection. Other approaches are possible. For example, because spectral analysis typically requires a stationary object, the microsphere analyzer preferably includes a mechanism to stop a microsphere within the flow stream for a period of time to allow a spectrophotometer to perform a spectral analysis. Any of these mechanisms, developed more fully below, can also be utilized to delay the passage of a microsphere from fluorescence detection to spectral detection.

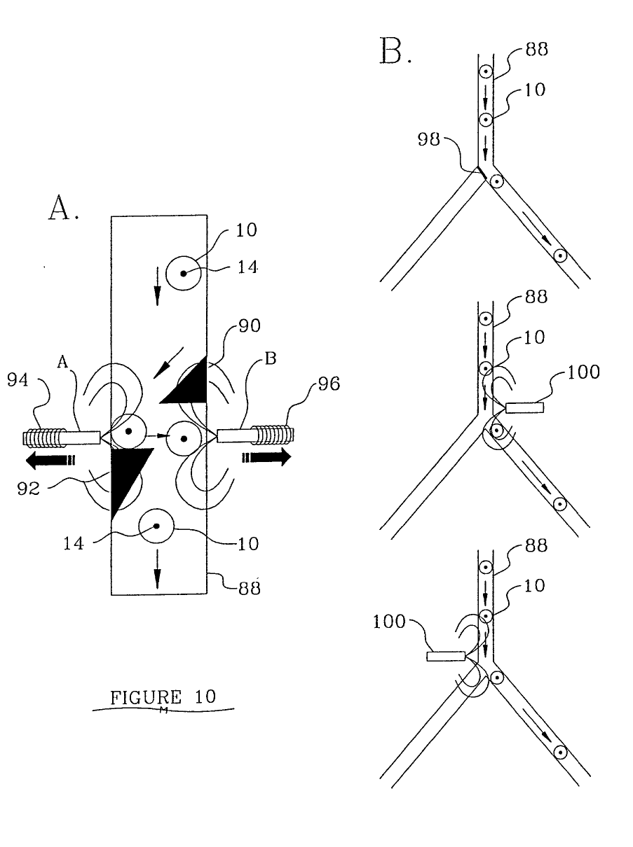

FIG. 10 illustrates various approaches that can be incorporated into the microsphere analyzer where desired. In a preferred embodiment, shown in FIG. 10a, the area within a tube 88 underneath a quartz imaging window 80 through which the spectral analysis is conducted contains an arrangement of a ledge 90 and a shelf 92 for temporarily stopping the microsphere 10. Also preferred, microspheres 10 having magnetic locus 14 are utilized, and first and second magnets 94, 96 are disposed about the periphery of the tube 88 near the quartz imaging window 80 to allow manipulation of the microsphere 10 based upon magnetic properties. In this embodiment, a ledge 90 is positioned on one side of the tube 88, and a shelf 92 is positioned on the opposite side. The ledge 90 is positioned such that it pushes a microsphere 10 within the flow stream toward the shelf 92. The shelf 92 is positioned such that it temporarily inhibits a microsphere 10 from continuing onward in the flow path. This temporary inhibition of flow occurs underneath the quartz imaging window 80 through which the spectral analysis is conducted. This temporary inhibition of the flow of microsphere 10 can be further enhanced by use of magnets 94, 96 disposed across the tube. For example, a first magnet 94 on the side having the shelf 92 can be turned on such that it attracts the microsphere 10 toward the wall of the tube 88 having the shelf 92. After spectral analysis is complete, this first magnet 94 can be turned off and a second magnet 96 on the opposite side of the tube 88 can be turned on. As FIG. 10a illustrates, this action attracts the microsphere 10 away from the shelf 92 and allows it to continue onward in the flow stream. FIG. 10b illustrates various alternative mechanisms to mechanically manipulate the flow of microspheres 10, such as flapper 98 valves and fluid jets 100.

These approaches to manipulating the flow of microspheres can be used to sort the microspheres. For example, the approaches can be used to sort one or more analytes from a sample containing a plurality of analytes. A preferred method of sorting according to the present invention comprises contacting the sample with a plurality of microspheres such that the ligands on the microsphere surfaces bind the appropriate analytes. The color-based address of each microsphere is determined, and each microsphere is then directed toward an appropriate chamber, such as a test tube of flask, selected from a plurality if chambers. The directing is preferably based upon the determining the color-based address. That is, each microsphere is selectively directed to one of a plurality of chambers based upon its color-based address.

As indicated above, the directing can comprise any suitable means of manipulating the flow of the microsphere. As illustrated in FIG. 10b, the microsphere can be bombarded with a stream of fluid from a fluid jet 100 such that its course is altered, or a wall member, such as a flapper valve 98, can be activated to alter the course of the microsphere such that it flows toward the appropriate chamber. Also, if the microspheres contain magnetic locii, selective activation of electromagnets can be used, as described above.

As illustrated in FIG. 4, the microsphere analyzer 50 of the present invention includes a computer 72. Preferably, the computer is a personal computer running an operating system that utilizes common features, such as standard window and menu appearances, etc., and facilitates the development and use of custom-made software. For example, the Windows operating systems, including Windows 3.1, Windows95, Windows98, Windows 2000, Windows Me, and Windows NT from Microsoft Corporation, are suitable. Preferably, the graphical user interface (GUI) of the computer is based on the Windows 2000 operating system. Also, various embodiments of UNIX will be suitable, as will any of the operating systems available from Apple Computer, Inc. Considering the functions of the computer in the apparatus of the current invention, the computer preferably includes a color monitor; floppy disk drive; a hard drive large enough to store files containing data typical of flow cytometric analyses as well as a lookup table, if appropriate; a network connection or modem for accessing remote storage drives and/or lookup tables, if appropriate; user input devices, such as a keyboard and a mouse; and various ports and other connectors and expansion cards, as appropriate, containing electronics for attaching the computer to the microsphere analyzer in a manner that allows the collection and processing of data. The computer may also contain other components, such as RAM, 2D and/or 3D video cards, a CD-ROM drive, a DVD-ROM drive, a CD-RW drive, a printer port, and a printer.

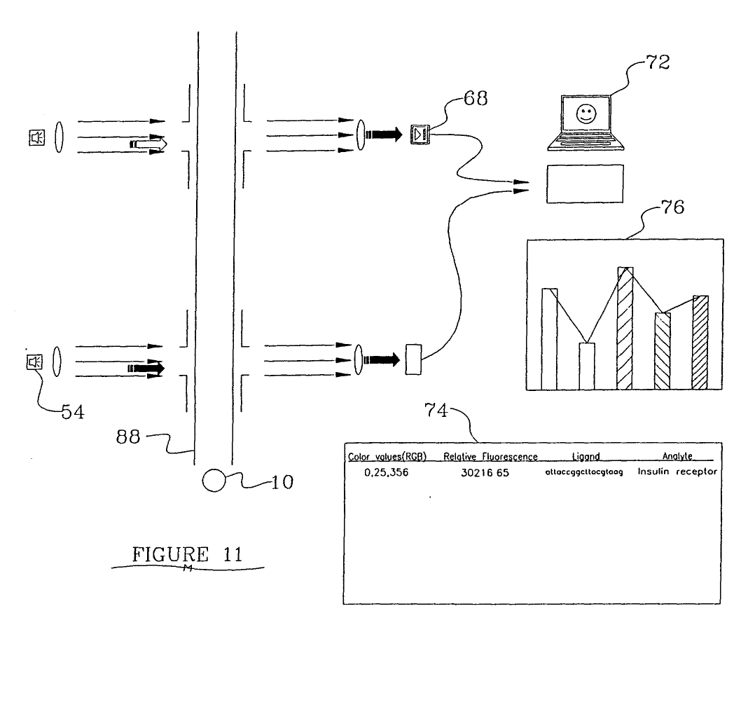

The look-up table is a data file that stores the color addresses of individual microspheres and associates each address with the ligand(s) or desired reaction product appropriate for a particular microsphere. For example, a look-up table for a microsphere library used for analyzing multiple analytes might contain data indicating that a glucose-binding ligand is present on microsphere 4719 (the color address). FIG. 11 illustrates acquisition of data from the look-up table and correlation of fluorescence data with address, ligand and analyte identification. The look-up table can be stored on the local computer or can be accessed on a remote computer via a network or other connection. Also, the look-up table may be protected by various passwords, encryption, or other software protection methods.

The GUI is designed to provide an optimal presentation of data as it is collected by the microsphere analyzer. Preferably, the GUI provides real-time, visual information regarding the data collected by the microsphere analyzer in a graphical format such as in a histogram plot or bar chart relating individual color addresses of microspheres and/or identity of an appropriate ligand and/or analyte to level of fluorescence detected. Preferably, as indicated above, this graphical presentation of data is continually updated as the analyzer conducts one or more analyses. The real-time updating can include continual adjustment of statistical parameters, such as mean fluorescence for a particular color address, confidence intervals, and total microspheres analyzed for a particular address and/or for a particular assay. Of course, any suitable output can be used, including printing of appropriate data.

The present invention also includes methods of using the microsphere analyzer. As indicated above, the microsphere analyzer of the present invention can be used for various types of analyses and other functions, including the analysis of a sample for the presence of a single or multiple analyte(s), and the synthesis of biomolecules, among others. Several additional methods and techniques have been developed for devices capable of detecting optical addresses that are different than the color addresses detected by the microsphere analyzer of the present invention. For example, U.S. Pat. No. 6,100,026 to Nova et al. for MATRICES WITH MEMORIES AND USES THEREOF contains detailed descriptions for such methods.

The analyzer is particularly well-suited for using the microspheres of the present invention to analyze a sample containing a plurality of analytes. Example 3 provides a suitable method for using the microsphere analyzer to detect the presence, absence, and/or concentration of multiple analytes in a sample. Preferably, the method involves analyzing a sample for at least three analytes. Any number of analytes can be analyzed, however, so long as the library of microspheres being utilized allows for a level of identification, based on color addresses, that is appropriate and/or desirable for the analysis being conducted.

The analyzer is also well-suited for the synthesis of biomolecules, such as polynucleotides and polypeptides. Combinatorial chemistry is used to synthesize polynucleotides using conventional techniques. U.S. Pat. No. 5,565,324 to Still et al. for COMPLEX COMBINATORIAL CHEMICAL LIBRARIES ENCODED WITH TAGS provides examples of such combinatorial techniques. A multitude of ligands can be synthesized in a stepwise fashion onto solid supports, such as the microspheres of the present invention, by sorting the beads into separate chambers, where separate reagents are located and appropriate reactions occur, allowing for the stepwise synthesis. The microspheres can be cycled through the analyzer repeatedly, with an appropriate reaction occurring for each microsphere during each cycle. The color address of the microsphere can be used to determine the appropriate reaction for the microsphere, preferably by consulting a look-up table, and the microsphere can be routed to the appropriate reaction chamber based on the various approaches to manipulating the microspheres outlined above. Following the reaction, the microsphere can be released and either sent through the analyzer for another cycle, if appropriate, or removed from the flow path.

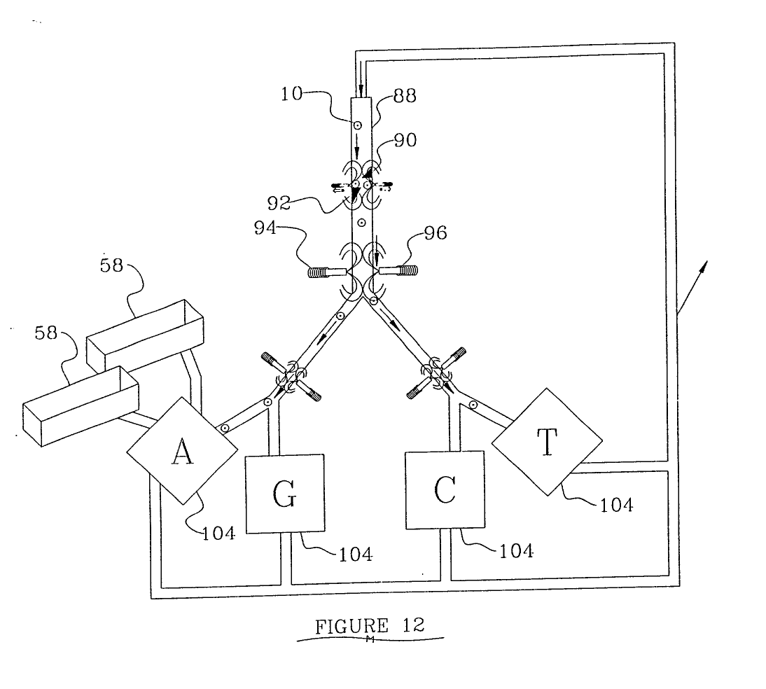

For example, polynucleotides can be synthesized through the stepwise addition of four separate nucleotides. FIG. 12 presents a schematic diagram of the synthesis of a polynucleotide using the analyzer 50 of the present invention. A look-up table can be created containing the nucleotide sequence of numerous polynucleotides and correlating the sequences to appropriate color addresses of individual microspheres. Depending on which nucleotide is to be added to the growing polynucleotide for a given cycle through the analyzer, the microsphere can be routed to the appropriate reaction chamber (i.e., either a reaction chamber for Adenine, Thymine, Cytosine, or Guanine for DNA polynucleotides). In this manner, thousands of polynucleotides can be synthesized simultaneously.

The present invention also includes kits comprising various materials that facilitate the use of a microsphere analyzer according to the present invention. For example, a kit may comprise a collection of microspheres, either as at least one microsphere having a unique address based upon color and a ligand on its surface, a set of microspheres having a common color address and a common surface ligand, multiple sets of microspheres, each set having a common color address and a common surface ligand, or a plurality of microspheres, each microsphere having a unique address based upon color and a unique ligand present on its surface, such that each color address correlates with a specific surface ligand. A kit according to the present invention may further comprise a look-up table 50 that contains data, which may be in the form of a text file, a database file, a spreadsheet file, or other similar file, for reading by an appropriate computer and correlating the ligand present on a microsphere present in the kit with the color address for that particular microsphere(s). Alternatively, the kit may include a password or other suitable piece of information that authorizes the user to access a look-up table located elsewhere, such as on a remote computer server. Kits according to the present invention may also include a container for storing microspheres, a packing medium or fluid in which the microspheres can be stored, a magnet for facilitating the separation of the microspheres based on the presence of a magnetic locus, a rack for holding containers and/or a magnet while separating the microspheres from a sample, and textual instructions for using the kit with the microsphere analyzer. Also, kits in accordance with the present invention may include fluorescent labels, appropriate modifying enzymes, a purification cartridge and reaction buffers.

### EXAMPLES

The following examples are included to demonstrate preferred embodiments and methods in accordance with the present invention. It should be appreciated by those of skill in the art that the apparatuses and techniques disclosed in the examples that follow represent embodiments and methods envisioned by the inventor to function well in the practice of the invention, and thus can be considered to constitute preferred modes for its practice. As such, the Examples are not to be construed to limit the invention to these preferred modes. Furthermore, those of skill in the art should appreciate that many changes can be made in the specific embodiments and methods that are disclosed and still obtain like or similar results without departing from the spirit and scope of the invention.

### Example 1

### Library of 10,000 Microspheres with Unique Color Addresses

A library of microspheres according to the present invention will be prepared. The library will contain at least 10,000 microspheres representing up to 10,000 unique color addresses. To achieve this number of unique color addresses, polystyrene microspheres with a magnetic locus will be doped with a blend of four color dyes—red, blue, green and yellow. Each dye will have ten different concentrations at which is can be added to the microsphere. Thus, an individual microsphere can be doped with 1 of 10 concentrations of red dye, 1 of 10 concentrations of blue dye, 1 of 10 concentrations of green dye, and 1 of 10 concentrations of yellow dye. Consequently, it will be possible to achieve 10,000 (10⁴) unique combinations of the dyes, and, therefore, the library can contain up to 10,000 unique color addresses. The library may contain two or more microspheres having the same color address.

A library in accordance with this Example will allow for the attachment of up to 10,000 unique ligands to the library, with one ligand being attached to one or more microspheres with the same color address. Such a library will allow for the efficient analyses of up to 10,000 different analytes in accordance with the present invention.

### Example 2

### Subsets of Color Addresses that Group Related Ligands

The use of color addresses allows for the grouping of microspheres into subsets that contain related ligands. For example, in a library of 100 unique microspheres, an investigator may want to define three subsets of ten microspheres each. In each subset, individual microspheres have ligands attached to their surface, and the ligands of the subset are preferably related to each other in some manner (e.g. antibodies directed at related antigens, genetic probes directed at related genes or transcripts thereof, etc.).

To accomplish the subsets, each microsphere bearing the related ligands will have a common portion of its address (the subset address), and a unique portion of its address (the subset member address). For example, for a subset containing ten microspheres, the dye levels for green, yellow and red will be set to a common value. This common value comprises the subset address. The blue dye will be unique for each microsphere in the subset, and will represent the subset member address. Table 1 illustrates this arrangement for a subset containing ten microspheres. As a result, the detection apparatus and computer can identify the subset as a group of related microspheres, while also identifying the individual microspheres as unique. This will be useful for presenting data to an investigator in a manner that highlights the relationship between members of the subset while still drawing the distinction between individual members of the subset.

TABLE I

| Dye | | Blue | Green | Yellow | Red |
|---|---|---|---|---|---|
| Microsphere 1 | Ligand A | 10 | 1 | 7 | 9 |
| Microsphere 2 | Ligand B | 9 | 1 | 7 | 9 |
| Microsphere 3 | Ligand C | 8 | 1 | 7 | 9 |
| Microsphere 4 | Ligand D | 7 | 1 | 7 | 9 |
| Microsphere 5 | Ligand E | 6 | 1 | 7 | 9 |
| Microsphere 6 | Ligand F | 5 | 1 | 7 | 9 |
| Microsphere 7 | Ligand G | 4 | 1 | 7 | 9 |
| Microsphere 8 | Ligand H | 3 | 1 | 7 | 9 |
| Microsphere 9 | Ligand I | 2 | 1 | 7 | 9 |
| Microsphere 10 | Ligand J | 1 | 1 | 7 | 9 |

| | |
|---|---|
| Subset member | Subset Address |
| address | |

### Example 3

### Analysis of a Sample for the Presence of Multiple Analytes

The following presents a detailed protocol suitable for using the microsphere analyzer and microspheres of the present invention to analyze gene expression profiles. In this example, mRNA transcripts comprise the analytes of interest, and corresponding ssDNA comprise the ligands. Thus, each microsphere in an appropriate library will be prepared to have multiple copies of the same ssDNA probe attached to its surface. A look-up table will be prepared that correlates each unique ssDNA probe with the appropriate color address.

1. Isolate total mRNA from the cell(s) and/or tissue(s) of interest.

2. Purify the total mRNA.

3. Label the mRNA with an appropriate fluorophore (e.g. FITC). It is important to note that fluorescent labeling may not be necessary, if, for example, one or more of the analytes being analyzed has natural fluorescence at desired wavelengths.

4. Expose the labeled mRNA to the library of microspheres under conditions suitable to allow hybridization between corresponding ligands and analytes.

5. Using the analysis apparatus of the present invention, determine the level of fluorescence, if any, and color address associated with each microsphere.

6. Consult the look-up table, and correlate, for each microsphere, fluorescence data with the color address.

7. Present the data in a manner that allows the investigator to determine whether a particular gene of interest had been expressed in the cell(s) and/or tissue(s) of interest.

The analyses can be multiplexed to allow repeated determinations for multiple genes, thus allowing for continual updating of the data as additional microspheres for the appropriate gene are handled by the analyzer. For example, if 1,000 genes are being analyzed, 600 microspheres, each with the same color address, can be assigned to 1 gene. This give a total of 600,000 microspheres, with 1,000 groups of 600 identical microspheres. In this method, an additional step can be included—continually update the data as additional analyses are conducted.

8. Continually update the data with real-time statistics as additional analyses are conducted.

All references cited in this disclosure, except in which they may contradict any statement or definition made herein, are incorporated by reference in their entirety.

The foregoing disclosure includes the best mode devised by the inventors for practicing the invention. It is apparent, however, that several variations in the apparatuses and methods of the present invention may be conceivable by one skilled in the art. Inasmuch as the foregoing disclosure is intended to enable one skilled in the pertinent art to practice the instant invention, it should not be construed to be limited thereby, but should be construed to include such aforementioned variations.

1. A method of analyzing a sample for the presence of one or more anlaytes, comprising:
contacting said sample with a plurality of microspheres, each of the plurality of microspheres comprising a solid support having an exterior surface, a color-based address comprising one or more dyes contained within the solid support and adapted to identify an individual microsphere, and a ligand attached to the exterior surface which binds one of said analytes;
detecting a level of fluorescence associated with each of the plurality of microspheres;
determining the color-based address of each of the plurality of microspheres; and
correlating the level of fluorescence of each of the plurality of microspheres with the color-based address for each of the plurality of microspheres.

2. The method according to claim 1, further comprising labeling at least one of said analytes with a fluorescent tag.

3. The method according to claim 1, further comprising outputting information based on the correlating the level of fluorescence.

4. The method according to claim 3, further comprising retrieving the identification of the ligand present on each of the plurality of microspheres from a look-up table.

5. The method according to claim 3, further comprising retrieving the identification of the analyte able to bind the ligand present on each of the plurality of microspheres from a look-up table.

6. The method according to claim 1, wherein the determining of the color-based address of each of the plurality of microspheres comprises determining an absorption spectra of light that has encountered the microsphere.

7. The method according to claim 6, wherein the light comprises white light.

8. The method according to claim 1, wherein the determining the color-based address of each of the plurality of microspheres comprises determining an absorption level at a peak absorbance for each of the one or more dyes.

9. The method according to claim 1, further comprising directing each of the plurality of microspheres into a chamber selected from a plurality of chambers;
wherein the directing is based upon the determining the color-based address of the microsphere.

10. The method according to claim 9, wherein the directing comprises selectively bombarding the microsphere with a stream of fluid.

11. The method according to claim 9, wherein the directing comprises selectively activating a wall member adapted to direct the microsphere toward the chamber upon activation.

12. The method according to claim 9, wherein each microsphere further comprises a magnetic locus, and wherein the directing comprises selectively activating one or more electromagnets adapted to direct the microsphere toward the chamber upon activation.

13. A method of sorting one or more analytes from a sample containing a plurality of analytes, comprising:
contacting said sample with a plurality of microspheres, each of the plurality of microspheres comprising a solid support having an exterior surface, a color-based address adapted to identify an individual microsphere, and a ligand attached to the exterior surface which binds one of said analytes;
determining the color-based address of each of the plurality of microspheres; and
directing each of the plurality of microsphere into a chamber selected from a plurality of chambers;
wherein the directing is based upon the determining the color-based address of the microsphere.

14. The method according to claim 13, wherein the directing comprises selectively bombarding the microsphere with a stream of fluid.

15. The method according to claim 13, wherein the directing comprises selectively activating a wall member adapted to direct the microsphere toward the chamber upon activation.

16. The method according to claim 13, wherein each microsphere further comprises a magnetic locus, and wherein the directing comprises selectively activating one or more electromagnets adapted to direct the microsphere toward the chamber upon activation.

17. The method according to claim 13, wherein the determining of the color-based address of each of the plurality of microspheres comprises determining an absorption spectra of light that has encountered the microsphere.

18. The method according to claim 13, wherein the color-based address of each of the plurality of microspheres comprises one or more dyes within the solid support of the microsphere; and
wherein the determining the color-based address of each of the plurality of microspheres comprises determining an absorption level at a peak absorbance for each of the one or more dyes.

19. A method of analyzing a sample for the presence of one or more anlaytes, comprising:
contacting said sample with a plurality of microspheres, each of the plurality of microspheres comprising a solid support having an exterior surface, a color-based address comprising one or more dyes contained within the solid support and adapted to identify an individual microsphere, and a ligand attached to the exterior surface which binds one of said analytes;
detecting a level of fluorescence associated with one of the plurality of microspheres;
determining an absorption spectra of light that has encountered the one of the plurality of microspheres;
repeating the detecting a level of fluorescence and determining an absorption spectra for each of the plurality of microspheres; and
correlating the level of fluorescence for each of the plurality of microspheres with the absorption spectra for each of the plurality of microspheres.

20. The method according to claim 19, further comprising directing each of the plurality of microspheres into a chamber selected from a plurality of chambers;
wherein the directing is based upon the absorption spectra determined for light that has encountered the microsphere.
